(19) United States
(12) Patent Application Publication
(10) Pub. No.: US 2015/0002748 A1
(43) Pub. Date: Jan. 1, 2015

(54) TELEVISION APPARATUS AND REMOTE CONTROLLER

(71) Applicant: Kabushiki Kaisha Toshiba, Tokyo (JP)

(72) Inventors: Hirofumi Kanai, Fukaya-shi (JP); Hideyuki Toma, Kodaira-shi (JP)

(21) Appl. No.: 14/296,312

(22) Filed: Jun. 4, 2014

Related U.S. Application Data
(63) Continuation of application No. PCT/JP2013/067854, filed on Jun. 28, 2013.

(51) Int. Cl. H04N 5/50; H04N 5/63

(52) U.S. Cl. CPC H04N 5/50; H04N 5/63
USPC 348/730

(57) ABSTRACT

According to one embodiment, a television apparatus includes a reproduction processor configured to perform signal processing on stream and to reproduce video and audio, a power source configured to supply power to reproduction processor when television apparatus is in an operation state, and not to supply power to reproduction processor when television apparatus is in a standby state, a MHL terminal comprising a power supply bus configured to supply first power to an external device, and a controller configured to supply first power to external device by power supply bus when television apparatus is in operation state, and to determine whether to supply first power to external device by power supply bus when television apparatus is in standby state.

### CROSS REFERENCE TO RELATED APPLICATIONS

This application is a Continuation Application of PCT Application No. PCT/JP2013/067854, filed Jun. 28, 2013, the entire contents of which are incorporated herein by reference.

### FIELD

Embodiments described herein relate generally to a television apparatus and a remote controller.

### BACKGROUND

Conventionally, electronic apparatuses which can record and reproduce video contents (streams) such as movies, TV programs and games are generally widespread.

Also, electronic apparatuses conforming to a standard for transmitting data, such as a Universal Serial Bus (USB) (registered trademark) are generally widespread. It should be noted that the USB is a communication standard by which a power source as well as data can be supplied. An electronic apparatus can supply the power source to an apparatus connected by the USB. Further, some electronic apparatuses can supply the power source to the apparatus connected by the USB even when they are in a standby state (sleep state).

In recent years, electronic apparatuses conforming to a standard for transmitting data, such as a Mobile High-definition Link (MHL) (registered trademark) are also widespread. MHL is a communication standard by which a power source as well as data can be supplied. An electronic apparatus can supply the power source to an apparatus connected by MHL. Also, an electronic apparatus which can supply the power source to the apparatus connected by MHL even in the standby state is desired.

Embodiments described herein aim to provide a television apparatus and a remote controller having higher convenience.

A television apparatus according to an embodiment is a television apparatus for reproducing video and audio based on a stream, comprising a reproduction processor configured to perform signal processing on the stream and to reproduce video and audio, a power source configured to supply power to the reproduction processor when the television apparatus is in an operation state, and not to supply power to the reproduction processor when the television apparatus is in a standby state, an MHL terminal comprising a power supply bus configured to supply power to an external device, a controller configured to supply the power to the external device by the power supply bus when the television apparatus is in the operation state and to switch whether to supply the power to the external device by the power supply bus when the television apparatus is in the standby state.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a figure illustrating a television apparatus according to an embodiment.

FIG. 2 is a figure illustrating the television apparatus according to the embodiment.

FIG. 3 is a figure illustrating a remote controller according to the embodiment.

FIG. 4 is a figure illustrating the television apparatus according to the embodiment.

FIG. 5 is a figure illustrating the television apparatus according to the embodiment.

### DETAILED DESCRIPTION

Various embodiments will be described hereinafter with reference to the accompanying drawings.

In general, according to one embodiment, a television apparatus for reproducing video and audio based on a stream, comprises a reproduction processor, a power source, a Mobile High-definition Link (MHL) terminal, and a controller. The reproduction processor configured to perform signal processing on the stream and to reproduce video and audio. The power source configured to supply power to the reproduction processor when the television apparatus is in an operation state, and not to supply power to the reproduction processor when the television apparatus is in a standby state. The Mobile High-definition Link (MHL) terminal comprising a power supply bus configured to supply first power to an external device. The controller configured to supply the first power to the external device by the power supply bus when the television apparatus is in the operation state, and to determine whether to supply the first power to the external device by the power supply bus when the television apparatus is in the standby state.

A television apparatus and a remote controller according to an embodiment will be hereinafter described in detail with reference to the accompanying drawings.

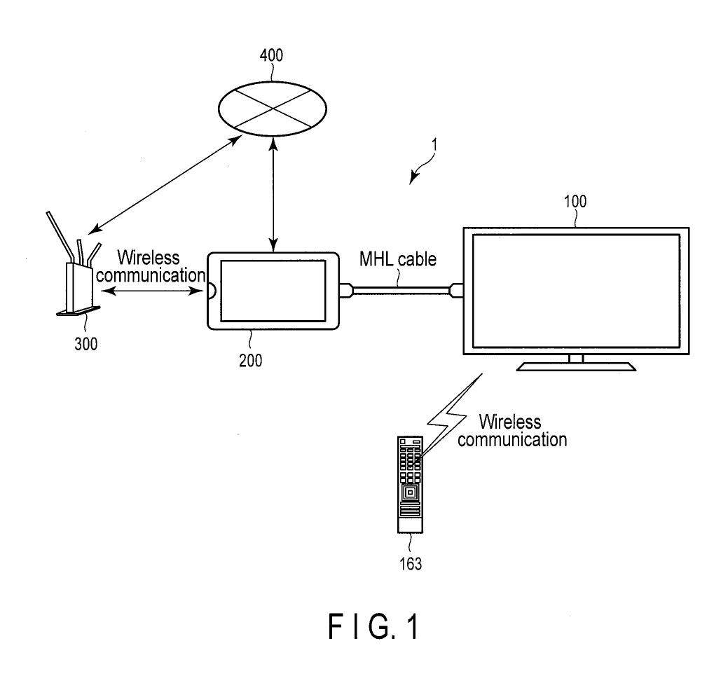

FIG. 1 illustrates an example of the television apparatus and various devices connected to the television apparatus.

A television apparatus (video processor) 100 is an electronic apparatus such as a broadcast receiver which can reproduce, for example, a broadcast signal or a video content stored in a storage medium. The video processor 100 can wirelessly communicate with a remote controller 163.

A mobile device 200 is an electronic apparatus comprising a display, an operation portion and a communication portion. The mobile device 200 is, for example, a cellular phone device, a tablet personal computer, a portable music player, a game console, a digital versatile disc (DVD) recorder, a set-top box or other electronic apparatuses.

A wireless communication terminal 300 can perform wireless or wired communication with the video processor 100 and the mobile device 200. That is, the wireless communication terminal 300 functions as an access point of the wireless communication. Also, the wireless communication terminal 300 can be connected to a network 400 such as an exterior cloud service. That is, the wireless communication terminal 300 can access the network 400 in response to a request from the video processor 100 or the mobile device 200. Accordingly, the video processor 100 and the mobile device 200 can acquire various kinds of data from a server on the network 400 via the wireless communication terminal 300.

Also, the video processor 100 is connected to the mobile device 200 by a communication cable corresponding to an MHL (MHL cable). The MHL cable is a cable comprising a terminal in a shape conforming to the High-definition Multimedia Interface (HDMI) (registered trademark) standard (HDMI terminal) at one end, and a terminal in a shape conforming to the USB standard (for example, micro USB) (USB terminal) at the other end.

MHL is an interface standard by which video data (stream) including video and audio can be transmitted. In MHL, an electronic apparatus (source apparatus) on the side of outputting the stream outputs the stream to an electronic apparatus (sink apparatus) on the side of receiving the stream by the MHL cable. The sink apparatus can reproduce the received stream and display the reproduced video in the display. Also, the source apparatus and the sink apparatus can operate and control one of the apparatuses by transmitting a command to the other apparatus connected by the MHL cable.

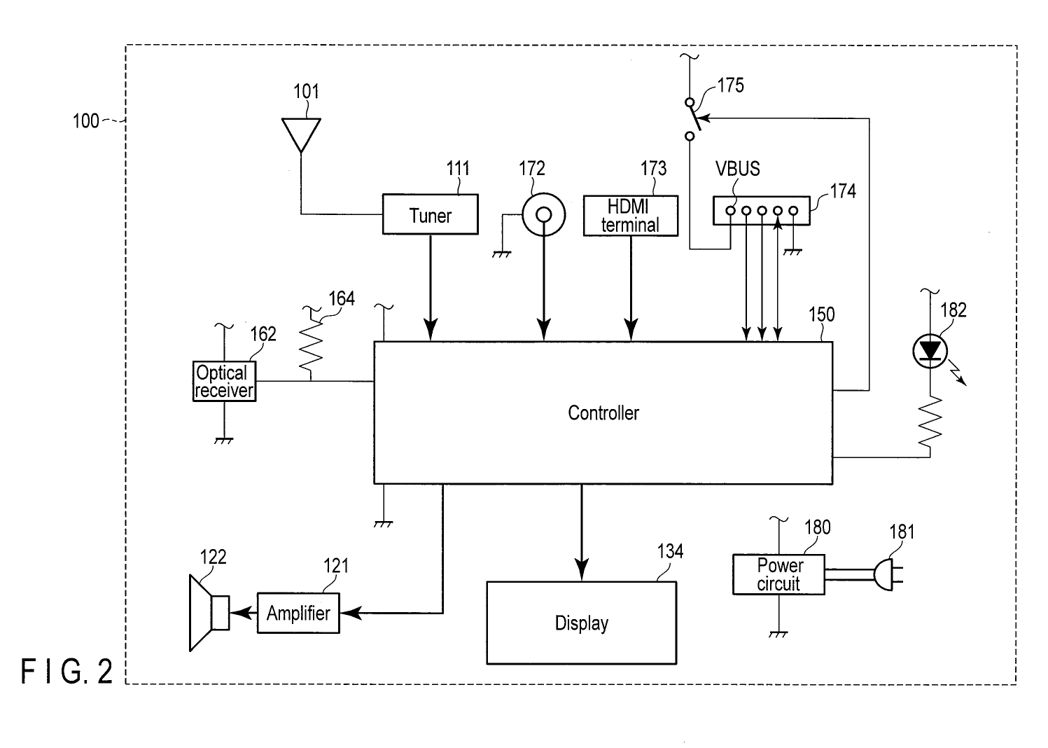

FIG. 2 is an example of the video processor 100 according to the embodiment.

The video processor 100 is a broadcast receiver or an electronic apparatus such as a recorder which can reproduce, for example, a broadcast signal or a video content stored in a storage medium.

The video processor 100 comprises a tuner 111, a speaker amplifier 121, a speaker 122, a display 134, a controller 150, an optical receiver 162, a composite input terminal 172, an HDMI terminal 173, an MHL terminal 174, a power circuit 180 and an indicator 182.

The tuner 111 can receive, for example, a digital broadcast signal received by an antenna 101. The antenna 101 can receive, for example, a terrestrial digital broadcast signal, a broadcasting satellite (BS) digital broadcast signal and/or a 110 degrees communication satellite (CS) digital broadcast signal. The tuner 111 can receive data (stream) of a content such as a program to be supplied by the above-described digital broadcast signal.

The tuner 111 is a tuner for the digital broadcast signal. The tuner 111 performs tuning of the received digital broadcast signal. The tuner 111 transmits the tuned digital broadcast signal to the controller 150. It should be noted that the video processor 100 may comprise a plurality of tuners 111. The video processor 100 can simultaneously tune a plurality of broadcast signals by a plurality of tuners.

The controller 150 is a processor configured to perform various types of signal processing in the video processor 100. Also, the controller 150 can control an operation of each part of the video processor 100. The controller 150 comprises a CPU, a ROM, a RAM, a nonvolatile memory, etc.

The ROM stores a program for controlling the video processor 100, a program for realizing various types of functions, etc. The RAM functions as a work memory of the CPU. That is, the RAM stores a calculation result of the CPU, data read by the CPU, etc. The nonvolatile memory stores various types of setting information, a program, etc. The CPU starts the program stored in the ROM or the nonvolatile memory based on an operation signal. This allows the controller 150 to perform various types of signal processing and to control an operation of each part.

The controller 150 demodulates the received digital broadcast signal. Then, the controller 150 acquires video data such as a transport stream (TS) (hereinafter referred to as stream) from the digital broadcast signal. It should be noted that the controller 150 can demodulate each of the plurality of signals tuned by the plurality of tuner 111.

As shown above, the antenna 101, the tuner 111 and the controller 150 function as receiving means for receiving the stream.

The controller 150 performs signal processing such as separation of a stream. That is, the controller 150 separates the stream into a digital video signal, a digital audio signal and the other data signals. It should be noted that the controller 150 can separate a plurality of streams.

Also, the controller 150 can convert a stream into recordable data (recording stream). The controller 150 can supply the recording stream to a storage not shown or other modules.

Furthermore, the controller 150 can convert (transcode) a bit rate of a stream from the original bit rate into another bit rate. That is, the controller 150 can transcode the stream having the original bit rate acquired based on a broadcast signal, etc., into a stream having a lower bit rate. This allows the controller 150 to record a content with a low capacity.

In addition, the controller 150 converts a digital audio signal into a signal (audio signal) formatted to be reproducible by the speaker 122. For example, the controller 150 converts the digital audio signal into the audio signal by digital-to-analogue conversion. The controller 150 supplies the audio signal to the speaker amplifier 121. The speaker amplifier 121 amplifies the received audio signal, and supplies the amplified audio signal to the speaker 122. The speaker 122 reproduces audio based on the supplied audio signal.

Furthermore, the controller 150 converts a digital video signal into a video signal formatted to be reproducible by the display 134. That is, the controller 150 decodes (reproduces) the digital video signal into the video signal formatted to be reproducible by the display 134.

That is, the controller 150 performs signal processing on a stream, and functions as a reproduction processor reproducing video and audio.

In addition, the controller 150 performs image quality adjustment processing of color, brightness, sharpness, contrast or the like, for example, on a video signal. The controller 150 supplies the video signal on which the image quality adjustment is performed to the display 134. The display 134 displays video based on the video signal to be supplied.

The display 134 comprises, for example, a liquid crystal display panel comprising a plurality of pixels arranged in a matrix, a liquid crystal display comprising a backlight configured to light this liquid crystal panel, etc. The display 134 displays video based on the video signal supplied from the controller 150.

It should be noted that the video processor 100 may have a structure comprising an output terminal configured to output the video signal instead of the display 134. Also, the video processor 100 may have a structure comprising an output terminal configured to output the audio signal instead of the speaker 122. Also, the video processor 100 may have a structure comprising an output terminal configured to output the digital video signal and the digital audio signal.

The optical receiver 162 comprises, for example, a sensor configured to receive an operation signal from the remote controller 163, etc. The optical receiver 162 supplies the received signal to the controller 150. The controller 150 decodes an original operation signal transmitted from a remote controller 163 by receiving the signal supplied from the optical receiver 162 and amplifying and demodulating the received signal. That is, the optical receiver 162 and the controller 150 function as an operation signal receiver configured to receive an operation signal.

It should be noted that a circuit for boosting the signal output from the optical receiver 162 is formed between the optical receiver 162 and the controller 150. For example, when a resistor 164 is connected between the output terminal of the optical receiver 162 and the power circuit 180, the signal output from the output terminal of the optical receiver 162 is boosted to an electrical potential of the power circuit 180. Accordingly, the controller 150 can receive a signal by which high and low can be identified. As a result, the controller 150 can decode the original operation signal from the signal supplied from the optical receiver 162.

The remote controller 163 comprises various operation keys. The remote controller 163 generates an operation signal in accordance with an operation of each key, and outputs the generated operation signal. That is, the remote controller 163 generates the operation signal based on a user's operation input. The remote controller 163 transmits the generated operation signal to the optical receiver 162 by infrared communication. The remote controller 163 comprises a transmitter configured to transmit, for example, the operation signal as infrared rays. It should be noted that the optical receiver 162 and the remote controller 163 may have a structure of transmitting and receiving the operation signal by other wireless communications such as a radio wave.

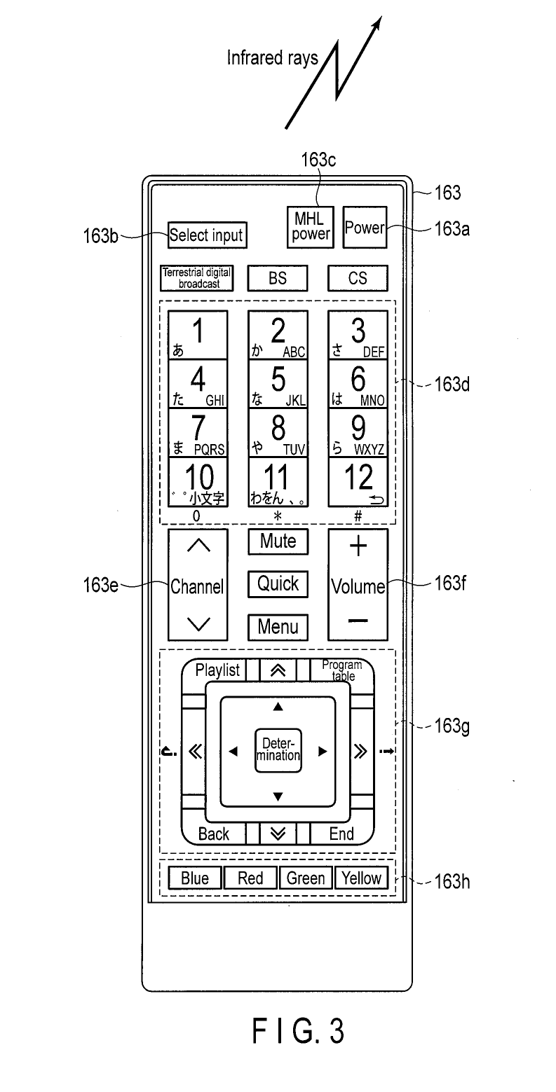

FIG. 3 illustrates a configuration example of the remote controller 163.

The remote controller 163 comprises a power key 163a, an input changeover key 163b, an MHL power key 163c, a number key 163d, a channel key 163e, a volume key 163f, a cursor key 163g, a color key 163h, etc. The remote controller 163 generates an operation signal in accordance with an operation of each key, and outputs the generated operation signal. For example, the remote controller 163 outputs the operation signal by the infrared rays.

The power key 163a is a key for causing the video processor 100 to switch a power state.

The input changeover key 163b is a key for causing the video processor 100 to switch a broadcast signal and an input terminal of a content.

The MHL power key 163c is a key for switching whether or not to supply a power source to an apparatus connected to the MHL terminal 174 to be described later.

The number key 163d is a key for causing the video processor 100 to perform tuning. The video processor 100 tunes a broadcast signal (selects channels) based on an operation signal corresponding to the number key 163d.

The channel key 163e is a key for causing the video processor 100 to perform tuning. The volume key 163f is a key for causing the video processor 100 to adjust the volume.

The cursor key 163g is a key for causing the video processor 100 to perform various types of processing. The cursor key 163g comprises a four-way key, a determination key, an program table key, a playlist key, a back key, an end key, etc. The video processor 100 performs selection of various items on a screen based on an operation signal corresponding to the four-way key and the determination key.

Also, the video processor 100 performs switching, etc., of a recording list screen, a program table screen, and other display screens based on an operation signal corresponding to the back key. Also, the video processor 100 finishes the display in the recording list screen, the program table screen, the other display screens, etc. based on an operation signal corresponding to the end key.

Also, the video processor 100 generates a program table screen based on a broadcast signal on the basis of an operation signal corresponding to the program table key, and displays the program table screen on the display 134. Furthermore, the video processor 100 generates a screen (recording list screen) indicating a list of recorded contents (recording list) which can be reproduced by the video processor 100 based on an operation signal corresponding to the playlist key, and displays the recording list screen on the display 134.

The color key 163h is a key for causing the video processor 100 to perform various operations. The composite input terminal 172, the HDMI terminal 173 and the MHL terminal 174 are wire communication portions for transmitting data to other apparatuses by wire. The composite input terminal 172 is an input terminal for receiving a video signal and an audio signal. The HDMI terminal 173 is a terminal for transmitting data based on the HDMI standard. The MHL terminal 174 is a terminal for transmitting data based on the MHL standard.

The composite input terminal 172, the HDMI terminal 173 and the MHL terminal 174 supply each of received signals to the controller 150. The controller 150 decodes the signals supplied from the composite input terminal 172, the HDMI terminal 173 and the MHL terminal 174, and acquires original video signals and audio signals. Accordingly, the video processor 100 can reproduce a stream received by the composite input terminal 172, the HDMI terminal 173 or the MHL terminal 174.

It should be noted that the controller 150 selects any of modules of the tuner 111, the composite input terminal 172, the HDMI terminal 173 and the MHL terminal 174 based on an operation of the input changeover key 163b of the remote controller 163. The controller 150 outputs video and audio from the speaker 122 and the display 134 based on the signal supplied from the selected module.

It should be noted that the MHL terminal 174 may be formed as part of the HDMI terminal 173. That is, part of a plurality of contact terminals of the HDMI terminal 173 may be formed to function as the MHL terminal 174.

Also, a terminal connected to the video processor 100 of the MHL cable comprises a structure compatible with an HDMI cable. It should be noted that a resistance is connected between terminals of the MHL cable, which is not used for communication (terminals for detection). The controller 150 can recognize whether the MHL cable is connected to the video processor 100 and whether the HDMI cable is connected to the video processor 100 by applying a voltage to the terminals for detection.

The video processor 100 can receive and reproduce a stream output from an apparatus (source apparatus) connected to the MHL terminal 174. Also, the video processor 100 can output a stream to an apparatus (sink apparatus) connected to the MHL terminal 174.

The power circuit 180 receives power from a commercial power source, etc., via an AC code 181, etc. The power circuit 180 converts a received alternating-current power into a direct-current power, and supplies it to each portion in the video processor 100. For example, the power circuit 180 is a power source configured to output power to the controller 150, the optical receiver 162, the resistor 164, the indicator 182, etc.

Also, the video processor 100 may comprise a LAN interface which can communicate with other apparatuses on the network 400 via the wireless communication terminal 300 by a LAN or a wireless LAN. This allows the video processor 100 to communicate with the other apparatuses connected to the wireless communication terminal 300. For example, the video processor 100 can acquire and reproduce a stream recorded in an apparatus on the network 400 by the LAN interface.

Also, the mobile device 200 can receive and reproduce a stream output from an apparatus (source apparatus) connected by the MHL cable. Also, the mobile device 200 can generate a stream based on video and audio output from its display and speaker. In addition, the mobile device 200 can output the generated stream to an apparatus (sink apparatus) connected by the MHL cable.

For example, if the mobile device 200 is the source apparatus and the video processor 100 is the sink apparatus, the mobile device 200 comprises a transmitter and a receiver. Also, the video processor 100 comprises a transmitter and a receiver.

The transmitter and the receiver are connected by the MHL cable. The MHL cable has lines such as VBUS, GND, CBUS, MHL+, MHL−, etc.

The VBUS is a power supply bus for transmitting power. For example, the sink apparatus supplies power of +5V to the source apparatus by the VBUS. The source apparatus can be operated by the power supplied from the sink apparatus by the VBUS. For example, the power source of the mobile device 200 which is the source apparatus can charge power supplied from the sink apparatus by the VBUS in a battery. The GND is a grounded line.

The CBUS is a line for transmitting a control signal such as a command. The CBUS is used for bidirectionally transmitting, for example, a display data channel (DDC) command or an MHL sideband channel (MSC) command. The DDC command is used for reading extended display identification data (EDID), performing high-bandwidth digital content protection (HDCP) authentication, etc. The EDID is a list of display information preset in accordance with a specification of a display, etc. Also, the MSC command is used for reading and writing various registers not shown, performing remote control, etc.

For example, the video processor 100 which is the sink apparatus outputs a command to the mobile device 200 which is the source apparatus by the CBUS. The mobile device 200 can execute various types of processing in accordance with the received command.

By transmitting the DDC command to the sink apparatus, the source apparatus can perform HDCP authentication with the sink apparatus, and read the EDID from the sink apparatus.

The HDCP is a method of encrypting a signal transmitted between apparatuses. The video processor 100 and the mobile device 200 transmit and receive a key, etc., and performs mutual authentication in a procedure conforming to the HDCP. When the video processor 100 and the mobile device 200 are mutually authenticated, they can exchange an encrypted signal with each other.

Also, the mobile device 200 analyzes the EDID obtained from the video processor 100, and recognizes display information indicating a format such as a resolution, color depth and a transmission frequency which can be processed by the video processor 100. The mobile device 200 generates a stream in a format such as the resolution, the color depth and the transmission frequency which can be processed by the video processor 100.

MHL+ and MHL− are lines for transmitting data. The two lines, MHL+ and MHL− function as a twisted pair. For example, MHL+ and MHL− function as a transition minimized differential signaling (TMDS) channel configured to transmit data in a TMDS method. Also, MHL+ and MHL− can transmit a synchronization signal (MHL clock) in the TMDS method.

For example, the source apparatus can output a stream to the sink apparatus by the TMDS channel. The video processor 100 receives a stream transmitted by the TMDS channel, performs signal processing on the received stream, and reproduces it.

In addition, the video processor 100 may generate a control signal for controlling the mobile device 200 connected by the MHL cable based on an operation signal generated by the remote controller 163, an operation input portion 161 or the like. In this case, the video processor 100 transmits the control signal to the mobile device 200 via the CBUS of the MHL cable. This allows the video processor 100 to control an operation of the mobile device 200.

The video processor 100 comprises an operation state and a standby state. When the video processor 100 is in the operation state, the power circuit 180 supplies power to each of modules in the controller 150 and the video processor 100. The video processor 100 can perform signal processing and output video and audio in the operation state.

Also, when the video processor 100 is in the standby state, the power circuit 180 supplies power to part of the optical receiver 162 and the controller 150. When the video processor 100 is in the standby state, the power circuit 180 supplies power at least to a module concerning reception of a specific operation signal. When being in the standby state, the video processor 100 operates a module for receiving the specific operation signal, and becomes in a state where no processing by other modules is executed. That is, when being in the standby state, the video processor 100 becomes in a state where no video or audio is output.

That is, the power circuit 180 comprises a structure in which power is supplied to each module including a module concerning reproduction of a stream when the video processor 100 is in the operation state, and no power is supplied to the module concerning reproduction of a stream when the video processor 100 is in the standby state.

Also, the video processor 100 comprises a switch 175 between the power circuit 180 and the VBUS of the MHL terminal 174. The controller 150 of the video processor 100 can switch whether or not to output power from the VBUS of the MHL terminal 174 by switching the switch 175.

When the switch 175 is turned on, the controller 150 can output power of the power circuit 180 from the VBUS of the MHL terminal 174. On the other hand, when the switch 175 is turned off, the controller 150 can block the power circuit 180 and the VBUS of the MHL terminal 174. This allows the controller 150 to switch a circuit not to supply power to the VBUS of the MHL terminal 174.

When the video processor 100 is in the operation state, the controller 150 turns on the switch 175. That is, when the video processor 100 is in the operation state, the controller 150 controls the switch 175 to always supply power of the power circuit 180 to the VBUS of the MHL terminal 174.

Also, when the video processor 100 is in the standby state, the controller 150 switches the on/off state of the switch 175 in accordance with an operation signal. For example, when the video processor 100 is in the standby state, the controller 150 switches the on/off state of the switch 175 according to an operation signal generated in accordance with an operation of the MHL power key 163c of the remote controller 163. That is, when the video processor 100 is in the standby state, the controller 150 can switch whether or not to supply power output from the power circuit 180 to the VBUS of the MHL terminal 174.

According to the above structure, the video processor 100 can supply power to an apparatus connected to the MHL terminal 174 even in the standby state. Also, when the switch 175 configured to switch in accordance with the operation of the MHL power key 163c of the remote controller 163 is provided between the power circuit 180 and the VBUS of the MHL terminal 174 as described above, the video processor 100 can always prevent power from being supplied to the VBUS of the MHL terminal 174. Thus, power can be saved in the video processor 100. As a result, a television apparatus and a remote controller with higher convenience can be provided.

It should be noted that the video processor 100 may have a structure of switching the on/off state of the switch 175 in accordance with the operation of the MHL power key 163c of the remote controller 163 in the operation state. The video processor 100 may have a structure of displaying a guidance display configured to indicate whether or not power is supplied to the VBUS of the MHL terminal 174 in the display 134, when the on/off state of the switch 175 is switched in accordance with the operation of the MHL power key 163c of the remote controller 163.

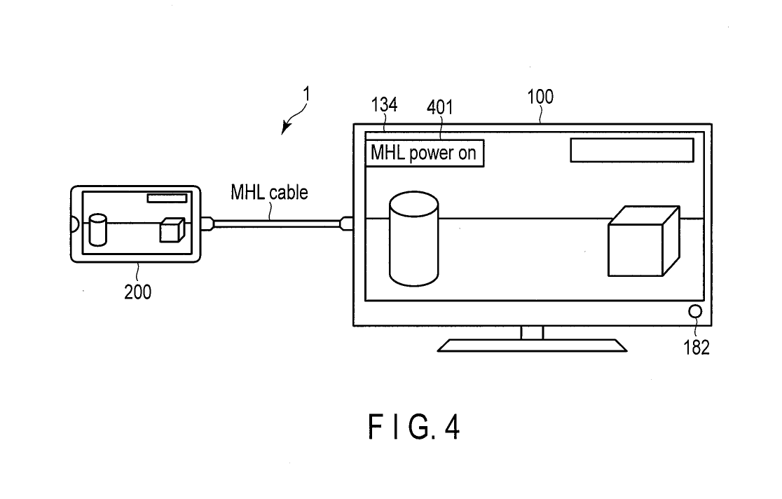

FIG. 4 illustrates a display example when video is output from the mobile device 200 to the video processor 100 by the MHL cable.

The mobile device 200 displays a screen in its display. Also, the mobile device 200 outputs a stream generated from the above screen to the video processor 100 via the MHL cable. This allows the video processor 100 to display the display screen of the mobile device 200 in the display 134.

In addition, the controller 150 of the video processor 100 displays a guidance display 401 as shown in FIG. 4 in the display 134, when the on/off state of the switch 175 is switched in accordance with the operation of the MHL power key 163c of the remote controller 163. For example, the controller 150 displays the guidance display 401 indicating that power is supplied to an apparatus connected to the MHL terminal 174 in the display 134, when the switch 175 is turned on in accordance with the operation of the MHL power key 163c of the remote controller 163. Also, for example, the controller 150 displays the guidance display 401 indicating that no power is supplied to an apparatus connected to the MHL terminal 174 in the display 134, when the switch 175 is turned off in accordance with the operation of the MHL power key 163c of the remote controller 163.

Accordingly, the video processor 100 can cause a user to easily recognize whether or not power is supplied to the apparatus connected to the MHL terminal 174.

In addition, the indicator 182 can cause a user to recognize the state of the video processor 100 by illuminating a light in accordance with the state of the video processor 100. The indicator 182 is a lighting device such as an LED, and illuminates the light based on the control of the controller 150. The indicator 182 can illuminate the light in at least a plurality of colors such as green, red and orange. The indicator 182 can indicate the state of the video processor 100 by the color of the light.

For example, when the video processor 100 is in the operation state, the controller 150 illuminates the indicator 182 in green. When the video processor 100 is in the standby state, and power is supplied to the VBUS of the MHL terminal 174, the controller 150 illuminates the indicator 182 in orange. When the video processor 100 is in the standby state, and no power is supplied to the VBUS of the MHL terminal 174, the controller 150 illuminates the indicator 182 in red. Accordingly, the video processor 100 can cause a user to easily recognize the state of the video processor 100.

Also, in the embodiment, the indicator 182 is described to have a structure indicating four types of states in total such as whether or not the video processor 100 is in the standby state, and whether or not power is supplied to the VBUS of the MHL terminal 174. However, the indicator 182 is not limited to this structure. An LED indicating only information of whether or not power is supplied to the VBUS of the MHL terminal 174 may be independently provided in the indicator 182. That is, the indicator 182 may have a structure comprising an LED indicating whether or not the video processor 100 is in the standby state, and an LED indicating whether or not power is supplied to the VBUS of the MHL terminal 174.

In addition, the controller 150 of the video processor 100 may output a beep, etc., from the speaker 122 when the on/off state of the switch 175 is switched in accordance with the operation of the MHL power key 163c of the remote controller 163 in the standby state. Accordingly, the video processor 100 can cause a user to easily recognize that the on/off state of the switch 175 has been switched.

Furthermore, the video processor 100 may comprise an audio reproducing state in which only audio is reproduced without displaying video. The controller 150 can switch the on/off state of the switch 175 in accordance with the operation of the MHL power key 163c of the remote controller 163 even when the video processor 100 is in the audio reproducing state.

In addition, the controller 150 illuminates the indicator 182, for example, in blue, when the video processor 100 is in the audio reproducing state, and power is supplied to the VBUS of the MHL terminal 174. Furthermore, the controller 150 illuminates the indicator 182, for example, in purple, when the video processor 100 is in the audio reproducing state, and no power is supplied to the VBUS of the MHL terminal 174.

As shown above, even when the video processor 100 is in the audio reproducing state, the video processor 100 can cause a user to easily recognize whether or not power is supplied to the VBUS of the MHL terminal 174.

Also, the video processor 100 may have a structure comprising a sub-controller requiring lower power consumption than the controller 150. Also, in the embodiment, although the video processor 100 is described to have a structure in which the power circuit 180 supplies power to part of the optical receiver 162 and the controller 150 when the video processor 100 is in the standby state, it is not limited to this structure. The video processor 100 may have a structure in which the power circuit 180 supplies power to the optical receiver 162 and the sub-controller, when the video processor 100 is in the standby state.

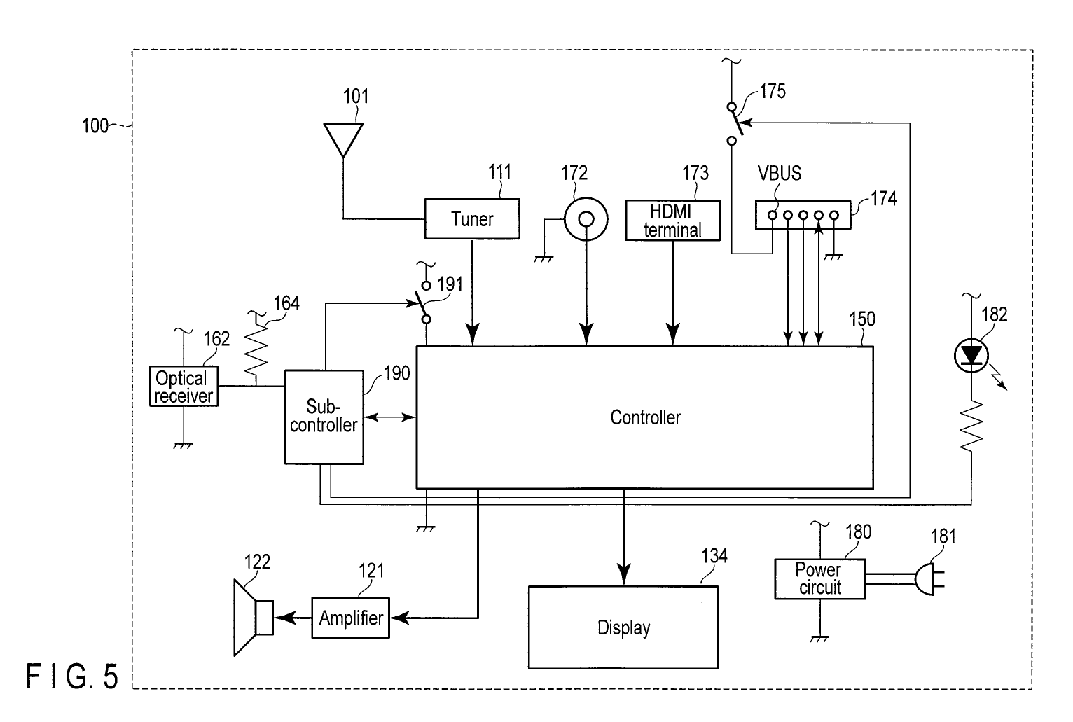

FIG. 5 illustrates an example when the video processor 100 comprises a sub-controller 190.

The video processor 100 in FIG. 5 further comprises the sub-controller 190 and a switch 191 in addition to the structure shown in FIG. 2.

The sub-controller 190 comprises part of functions of the controller 150 shown in FIG. 2. The sub-controller 190 comprises, for example, a function of decoding an original operation signal from a signal received by the optical receiver 162, a function of controlling the on/off state of the switch 175, a function of controlling the lighting of the indicator 182, and a function of controlling the on/off state of the switch 191. That is, the optical receiver 162 and the sub-controller 190 function as an operation signal receiver configured to receive an operation signal.

The power circuit 180 supplies power to the optical receiver 162 and the sub-controller 190 when the video processor 100 is in the standby state. When being in the standby state, the video processor 100 operates the optical receiver 162 and the sub-controller 190, and becomes in a state where no processing by other modules is executed. That is, when being in the standby state, the video processor 100 becomes in a state where no video or audio is output.

Also, the video processor 100 comprises the switch 175 provided between the power circuit 180 and the VBUS of the MHL terminal 174, and the switch 191 provided between the power circuit 180 and the controller 150. The sub-controller 190 of the video processor 100 can switch whether or not to output power from the VBUS of the MHL terminal 174 by switching the switch 175. Also, the sub-controller 190 of the video processor 100 can switch whether or not to supply power from the power circuit 180 to the controller 150 by switching the switch 191.

When the switch 175 is turned on, the sub-controller 190 can output power of the power circuit 180 from the VBUS of the MHL terminal 174. Also, when the switch 175 is turned off, the sub-controller 190 can block the power circuit 180 and the VBUS of the MHL terminal 174. This allows the sub-controller 190 to switch a circuit not to supply power to the VBUS of the MHL terminal 174.

The sub-controller 190 switches the on/off state of the switch 191 according to an operation signal generated in accordance with an operation of the power key 163a of the remote controller 163. That is, the sub-controller 190 turns on the switch 191, when the video processor 100 is in the standby state, and the operation signal generated in accordance with the operation of the power key 163a of the remote controller 163 is input. When the switch 191 is turned on, power of the power circuit 180 is supplied to the controller 150. This allows the sub-controller 190 to switch the video processor 100 from the standby state to the operation state.

The sub-controller 190 turns on the switch 175, when the video processor 100 is in the operation state. That is, when the video processor 100 is in the operation state, the sub-controller 190 controls the switch 175 in order for the power of the power circuit 180 to be always supplied to the VBUS of the MHL terminal 174.

Also, the sub-controller 190 switches the on/off state of the switch 175 in accordance with an operation signal when the video processor 100 is in the standby state. For example, the sub-controller 190 switches the on/off state of the switch 175 according to the operation signal generated in accordance with the operation of the MHL power key 163c of the remote controller 163 when the video processor 100 is in the standby state. That is, the sub-controller 190 can switch whether or not to supply power output from the power circuit 180 to the VBUS of the MHL terminal 174 when the video processor 100 is in the standby state.

According to the structure as described above, the video processor 100 can supply power to an apparatus connected to the MHL terminal 174. Also, when the switch 175 switched in accordance with the operation of the MHL power key 163c of the remote controller 163 is provided between the power circuit 180 and the VBUS of the MHL terminal 174 as described above, the video processor 100 can always prevent power from being supplied to the VBUS of the MHL terminal 174.

Also, since the sub-controller 190 requires lower power consumption than the controller 150, the power consumption when the video processor 100 is in the standby state can be reduced.

Also, the remote controller 163 may have a structure of recognizing the state of the video processor 100 by transmitting and receiving a signal to/from the video processor 100. In this case, the remote controller 163 comprises a communication portion configured to communicate with the video processor 100, a memory configured to store information and a display.

The remote controller 163 recognizes the state of the video processor 100 by transmitting and receiving a signal to/from the video processor 100. The remote controller 163 stores in the memory information indicating the recognized state of the video processor 100. The remote controller 163 displays the information indicating the state of the video processor 100 stored in the memory in the display.

That is, the remote controller 163 comprises a state recognition portion configured to recognize whether or not power of the power circuit 180 is supplied to a power supply bus of the MHL terminal 174 in the video processor 100. In addition, the remote controller 163 can display the recognition result of the state recognition portion in the display.

According to such a structure, the remote controller 163 can display whether the video processor 100 is in the operation state or in the standby state in the display, and cause a user to recognize it, even when the video processor 100 does not comprise the indicator 182. Also, the remote controller 163 can display whether or not power is supplied to the VBUS of the MHL terminal 174 in the display, and cause a user to recognize it.

It should be noted that the functions described in each of the above embodiments are not limited to a structure requiring hardware, but can be realized by causing a computer to read a program describing each function using software. Also, each function may be constituted by properly selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television apparatus for reproducing video and audio based on a stream, comprising:
a reproduction processor configured to perform signal processing on the stream and to reproduce video and audio;
a power source configured to supply power to the reproduction processor when the television apparatus is in an operation state, and not to supply power to the reproduction processor when the television apparatus is in a standby state;
a Mobile High-definition Link (MHL) terminal comprising a power supply bus configured to supply first power to an external device; and
a controller configured to supply the first power to the external device by the power supply bus when the television apparatus is in the operation state, and to determine whether to supply the first power to the external device by the power supply bus when the television apparatus is in the standby state.

2. The television apparatus of claim 1, wherein the controller comprises a switch provided between the power source and the power supply bus, and determines whether to supply the first power to the power supply bus by an on/off state of the switch.

3. The television apparatus of claim 2, further comprising:
an operation signal receiver configured to receive an operation signal,
wherein the controller controls the switch in order for the first power to be supplied to the power supply bus when receiving a first operation signal.

4. The television apparatus of claim 2, further comprising:
a speaker configured to produce a beep sound when a state of the switch is switched.

5. The television apparatus of claim 1, further comprising:
an indicator configured to indicate whether the first power is supplied to the power supply bus.

6. A remote controller for transmitting an operation signal to a television apparatus, the television apparatus comprising a reproduction processor configured to perform signal processing on a stream and to reproduce video and audio, a power source configured to supply power to the reproduction processor in an operation state and not to supply the power to the reproduction processor in an standby state, and an MHL terminal comprising a power supply bus for supplying first power to an external device, the remote controller comprising:
a signal generator configured to generate an operation signal for determining whether to supply the first power to the external device by the power supply bus when the television apparatus is in the standby state; and
a transmitter configured to transmit the operation signal to the television apparatus.

7. The remote controller of claim 6, further comprising:
a state recognition portion configured to recognize whether the first power is supplied to the power supply bus in the television apparatus; and
a display configured to display a recognition result of the state recognition portion.

8. The television apparatus of claim 3, further comprising:
a speaker configured to produce a beep sound when a state of the switch is switched.
